(19) United States
(12) Patent Application Publication
(10) Pub. No.: US 2003/0213652 A1
(43) Pub. Date: Nov. 20, 2003

(54) Residential elevator

(75) Inventor: Dwayne Creston Long, Neenah, WI (US)

Correspondence Address: WILHELM LAW SERVICE, S.C., 100 W LAWRENCE ST, THIRD FLOOR, APPLETON, WI, 54911

(73) Assignee: Waupaca Elevator Company, Inc., Appleton, WI

(21) Appl. No.: 10/146,676

(22) Filed: May 15, 2002

(51) Int. Cl. B66B 11/06

(52) U.S. Cl. 187/261; 187/349

(57) ABSTRACT

Novel residential elevators, and novel methods of installing and using residential elevators. A residential elevator of the invention typically includes guide rail structure, a car, lift apparatus, and cables connecting the lift apparatus to the car. The guide rail structure is mounted to the building. The car is mounted to the guide rail structure. The car has a range of upward and downward movement, along a path of travel between an upper limit and a lower limit. The lift apparatus lifts and lowers the car, and is mounted to the guide rail structure, at a location such that the lift apparatus is above the top of the car when the car is at the upper limit. Preferably, the cables extend directly from the car or car frame to the lift apparatus without passing over or around any sheave or around any other direction-changing structure.

### BACKGROUND

This invention relates to elevators for use in residential buildings. Such elevators include personnel elevators and/or dumb waiters. The invention also relates to methods of installing such elevators, and to methods of using such elevators.

Specifically, this invention relates to elevators which reduce or eliminate the amount of premium space occupied by the lift apparatus, and to methods for reducing the costs and labor associated with the traditionally complex installation of the lift apparatus, sheaves, and cable.

Conventional residential elevators typically have a lift apparatus comprising a drive unit such as a motor or other prime mover, and an associated winding unit which is driven by the prime mover. A gear box typically provides the interface between the prime mover and the winding unit. The gear box can be integral with the prime mover, integral with the winding unit, or may be a standalone separate and distinct unit.

During installation of the elevator, the drive unit, gear box, and winding unit are conventionally positioned somewhere to the side of the elevator shaft, and may be at or near the bottom of the elevator shaft. The output of the lift apparatus is generally connected to a cable set, or other elongate connection apparatus, which extends, around a number of sheaves, up above the top of the car, and thence over one of the sheaves and downwardly to the car, or downwardly to a frame which supports the car. The cables are thus connected to the car or car frame on one end and to the winding unit on the other end, with the sheaves guiding the cables between the car and the winding unit. The motor, the gear box, and the winding unit may be all positioned near the base of the elevator shaft, and cables run the height of the shaft, run about a sheave mounted above the upper limit of the range of movement of the top of the car, and thence connect to the top of the car or car frame.

Conventional residential elevators have two shortcomings which are addressed by this invention. The first shortcoming is that conventional residential elevators require a certain amount of e.g. premium value floor space to receive and mount the lift apparatus and some of the sheaves in such premium value floor space.

The second shortcoming of conventional residential elevators is the complexity of the mechanical layout of the lift apparatus and the cable path, especially the cost of the sheaves and cable, and importantly the installation cost since the position of each sheave must be separately and skillfully determined, and each sheave must be anchored to the building structure, with sufficient securement strength to withstand the various operational forces which are exerted on the sheave as the cable passes over the sheave and turns an angle at the respective sheave while the elevator is loaded to capacity.

To the inventor's knowledge, these shortcomings have been addressed as follows. Regarding space allocation, it is known to mount the lift apparatus at some mid-point of the path of travel of the car. Such implementations known to the inventor herein incorporate a counter weight. No known implementation of such mid-path lift apparatus mount is known to the inventor herein for use in residential elevators.

It is further known to place the lift apparatus above the elevator car, but such that the lift apparatus such as motor or winding unit extends below, and protrudes into, the upper limit of the path of travel of the car. Such known implementations include an indent in the configuration of the car, at the top of the car, to accommodate such protrusion of the lift apparatus into the path of travel of the car. Such indent diminishes the interior space of the car and requires further specialized construction and labor for car manufacture, as well as protruding into the inner space of the car at a height which can potentially increase the likely frequency of head injuries to users of the car.

It is an object of this invention to provide residential elevators and dumb waiters which reduce or eliminate the amount of premium floor or other space consumed by such elevators and/or dumb waiters.

It is another object of the invention to provide residential elevators and dumb waiters which reduce or eliminate the amount of premium space consumed by lift apparatus, sheaves, pulleys, and other utilities.

It is a further object of the invention to provide residential elevators and dumb waiters which are accompanied by reduced costs associated with materials, and with labor required to install such residential elevators and dumb waiters.

It is yet another object of the invention to provide residential elevators and dumb waiters which facilitate installation of such elevators and dumb waiters.

It is still another object of the invention to provide improved methods for using a residential elevator or dumb waiter.

It is a general object of the invention to make residential elevators and dumb waiters financially and logistically more accessible to a greater proportion of those in need of such products and services.

### SUMMARY

This invention provides novel residential elevators, novel methods of installing residential elevators, and novel methods of using residential elevators. Residential elevators of the invention are designed and configured for mounting in, on, or to buildings. Such residential elevator typically includes guide rail structure, a car, lift apparatus, and elongate connection apparatus such as cables connecting the lift apparatus to the car. The guide rail structure is mounted to the building in an upright orientation. The car is mounted to the guide rail structure. The car has a top, and has a range of upward and downward movement on the guide rail structure, along a path of travel between an upper limit and a lower limit. The lift apparatus lifts and lowers the car, and is mounted to the guide rail structure, at a location such that the lift apparatus is above the height of the top of the car when the car is at the upper limit of movement, and preferably such that the cables do not extend over any sheaves. Preferably, the cables extend directly from the car or car frame to the lift apparatus without passing over or around any sheave or around any other direction-changing structure.

Thus, this invention comprehends a residential elevator mounted in a building. The elevator comprises guide rail structure mounted to the building in an upright orientation; a car mounted to the guide rail structure, the car having a top, and a range of upward and downward movement on the guide rail structure along a path of travel between an upper limit and a lower limit; lift apparatus operable for lifting and lowering the car, the lift apparatus being mounted to the guide rail structure at a location above a height of the top of the car when the car is at the upper limit of movement; and elongate connection apparatus, such as cable, connecting the lift apparatus to the car, for lifting and lowering the car.

In preferred embodiments, the guide rail structure comprises a plurality of rails, suitable for mounting to the building in an upright orientation.

In some embodiments, the lift apparatus comprises an outer housing, and an internal drive unit disposed inwardly of the outer housing, the internal drive unit driving rotation of the outer housing, the cable being connected to the outer housing and being wound onto, and unwound from, an outer surface of the outer housing as the car travels upwardly and downwardly along the path of travel.

In preferred embodiments, the outer surface of the outer housing comprises guide grooves extending about a circumference of the outer surface, the guide grooves being sized and configured to receive the cable and to guide helical winding of the cable on the lift apparatus.

In certain embodiments, the lift apparatus comprises an internal drive unit, a brake, and an outer housing having an outer surface configured to receive the cable as the car is lifted, and to wind the cable on an outer surface of the outer housing in a helical pattern.

In some embodiments, the lift apparatus comprises a drive unit containing a drive mechanism, and a winding unit comprising an outer housing comprising the winding structure, the winding structure being configured to receive and wind the cable, the lift apparatus further comprising drive apparatus connecting a drive output of the drive mechanism to a winding input of the winding unit.

In some embodiments, the drive unit and the winding unit comprise separate and distinct structures, independently mounted to the guide rail structure.

In preferred embodiments, the elevator is devoid of any counterbalance effective to provide greater than 20 percent of a lift force required to lift the car when the car is loaded to capacity.

Also in preferred embodiments, the cable traverses a lift path between the car and the lift apparatus, the lift path being devoid of intervening sheaves between the car and the lift apparatus.

In preferred embodiments, the cable extends, from the car, upwardly to the winding structure along a straight-line connection path.

In a further expression of the invention, a residential elevator is mounted in a building. The residential elevator is limited to movement along a path of travel no more than 50 feet long. The residential elevator comprises guide rail structure mounted to the building in an upright orientation and extending generally along the 50 foot path of travel; a car mounted to the guide rail structure, the car having a top, and a range of upward and downward movement on the guide rail structure along the path of travel between an upper limit and a lower limit thereby to service the no more than 50 feet of travel; lift apparatus operable for lifting and lowering the car, the lift apparatus comprising an outer housing, and an internal drive unit disposed inwardly of the outer housing, the internal drive unit driving rotation of the outer housing, the lift apparatus being mounted to the guide rail structure at a location such that the outer housing is above a height of the top of the car when the car is at the upper limit of movement; and cable connecting the lift apparatus to the car, for lifting and lowering the car.

A yet further expression of the invention is a method of installing an elevator in a building. The method comprises mounting guide rail structure to the building in an upright orientation; mounting a car to the guide rail structure, the car having a top, and a range of upward and downward movement on the guide rail structure along a path of travel between an upper limit and a lower limit; mounting lift apparatus, operable for lifting and lowering the car, to the guide rail structure at a location such that the lift apparatus is above a height of the top of the car when the car is at the upper limit of movement; and mounting cable to the lift apparatus and to the car and thus connecting the lift apparatus to the car, for lifting the car and lowering the car

In preferred embodiments, the methods include installing a plurality of rails as the guide rail structure.

Some embodiments include selecting, as the lift apparatus, a lift apparatus comprising an outer housing, and internal drive structure disposed inwardly of the outer housing, the outer housing being configured to receive the cable as the car is lifted, and to wind the cable on an outer surface of the outer housing.

In preferred methods, the lift apparatus comprises a drive unit contained in a first housing and a winding unit comprising the winding structure contained in a second housing, the method comprising mounting the winding unit in a location such that the winding structure is positioned with respect to the path of travel of the car such that the cable extends from the car, upwardly to the winding structure without substantial change of direction of extension of the cable between the car and the winding structure.

In highly preferred embodiments, the method includes using the lift apparatus to provide at least 80 percent of a force, measured at the car, and required to lift the car when the car is loaded to capacity.

Also to highly preferred embodiments, the method includes traversing the cable along a lift path between the car and the lift apparatus without passing the cable over any sheaves.

The invention also contemplates a method of using an elevator, comprising traversing an elevator car along an upstanding guide rail structure attached to a building, such that the elevator car traverses the guide rail structure along a path of travel between an upper limit and a lower limit; and winding cable on a winding unit which is mounted to the guide rail structure, at a height which, at the upper limit of travel of the car, is above a top of the car.

### BRIEF DESCRIPTION OF THE DRAWINGS

FIG. 1 shows a pictorial view of a residential elevator of the invention.

FIG. 2 shows a front elevation of an all-in-one lift apparatus wherein the drive unit is housed inside the winding unit.

FIG. 3 shows a front elevation of a 2-part lift apparatus wherein the drive unit and winding unit are separate and distinct entities, connected by a drive shaft.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

As used hereinafter and in the claims which follow, the phrase “residential elevator” refers to elevators and dumb waiter lift devices which have lift heights wherein a car traverses a path of travel up to 50 feet in length. Such 50 foot maximum length of the path of travel is specified by code as the maximum travel path for residential elevators.

As used herein, the phrase “winding unit” refers to a structure which receives and winds up a length of cable as the elevator car is being lifted along a path of travel, for temporary storage of such cable until the car is subsequently lowered along the path of travel.

Residential elevators can have as many stops as desired along the 50 foot path of travel of the car. Typically such elevators service about 5 floors of a building along the 50 foot path of travel, although such elevators can well have e.g. 6 stops, and do, in some implementations, service as many as 6 residential floors. The electronic controllers which control such elevators can be programmed to provide any number of stops desired along the 50 foot length of the path of travel of the elevator car.

Where the path of travel exceeds 50 feet, code limitations classify such elevators as non-residential elevators and impose different design considerations. Because of these different design considerations, technical development of residential elevators and non-residential elevators have traveled divergent paths such that design criteria used in commercial elevators are not necessarily used in residential elevators; and design criteria used in residential elevators are not necessarily used in commercial elevators. Thus has the elevator art developed along such two divergent paths that design criteria useful in commercial elevators do not obviously transfer to residential elevator design. Similarly, residential elevator criteria do not obviously transfer to commercial elevator design. Accordingly, the inventive concepts disclosed herein are directed specifically toward residential elevators.

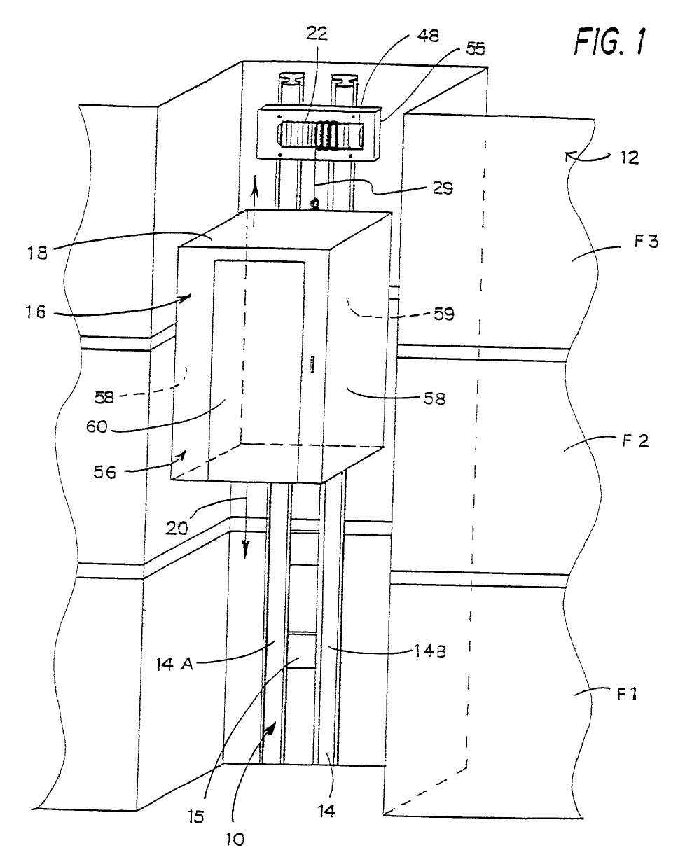

FIG. 1 illustrates a preferred embodiment of residential elevators of the invention. As seen in FIG. 1, a residential elevator 10 is installed in a building 12. A guide rail structure 14 is mounted to the building using brackets 15, in an upright orientation, illustrated in the drawings as a vertical orientation. The rail structure extends in an upright orientation between at least 2 floors illustrated in the drawings as three floors “F1”, “F2”, and “F3” of the building, up to a typical 5 or 6 floors of the building.

An elevator car 16 is mounted to guide rail structure 14 by conventional mounting wheels (not shown) or low friction sliding guides (not shown) interfacing between the car and individual ones of left and right guide rails 14A and 14B. In some embodiments, the car can be mounted to a car frame (not shown) and the car frame is mounted to the guide rail in place of the car. In such scenario, the car frame supports the car for movement of the car upwardly and downwardly along the guide rail.

Irrespective of the mechanism by which the car is mounted to guide rails 14A, 14B, the guide rail structure provides basis for path of travel 20 for movement of the car from one of the floors “F1”, “F2”, “F3”, to any other of the floors “F1”, “F2”, “F3”. Whatever the number of floors, the elevator electronic controller is typically programmed such that the elevator can stop at any of the floors in the building within the up to 50 foot length of the path of travel of the car.

Car 16 has a top 18 defined by a top wall. Car 16 further has a range of upward and downward movement on the guide rail, along the path of travel indicated by arrows 20 in FIG. 1, between an upper limit and a lower limit.

Lift apparatus 22, operable for lifting and lowering the car on guide rail structure 14, is mounted to a lift apparatus mounting bracket 55, which is in turn mounted to guide rail structure 14 at a location which is at a height such that the lift apparatus is above the height of the top 18 of the car when the car is at the upper limit of movement along path of travel 20, and wherein the car can have conventional rectangular dimensions throughout the inner space of the car, without protrusions into the inner space of the car to account for lifting apparatus mounted so low above the car as to interfere with the conventional rectangular shape of the inner passenger space inside the car.

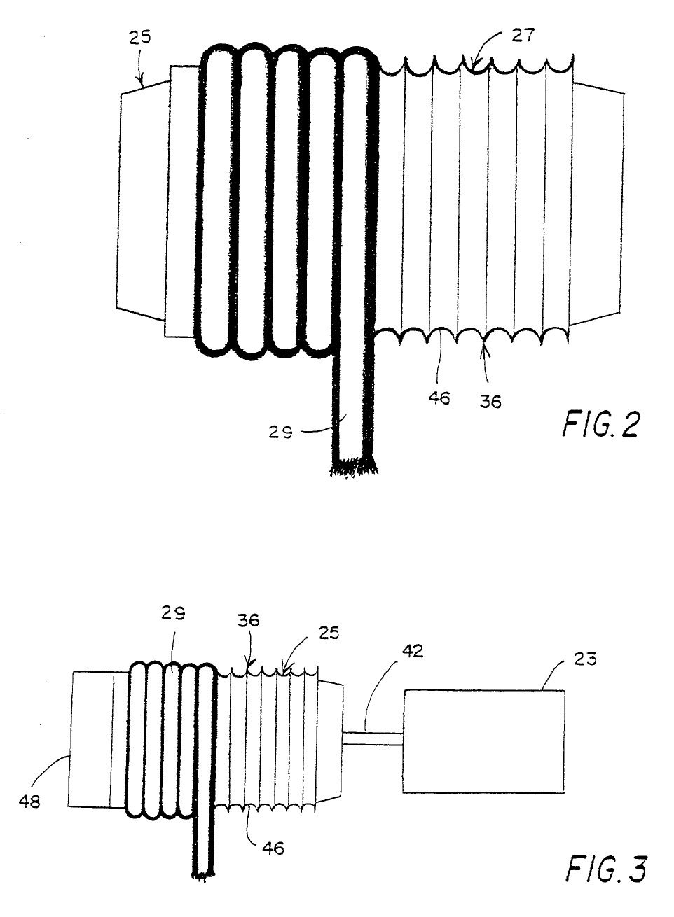

Lift apparatus 22 includes a prime mover, also referred to herein as a power unit, such as a motor 23 (FIG. 3), and a winding unit 25. The prime mover and winding unit can be embodied in an all-in-one unit 27 illustrated in FIGS. 1 and 2, wherein e.g. an internal drive unit such as motor 23 is disposed inwardly of an outer housing and wherein an outer surface of the outer housing has helically-arranged guide grooves 46. Such an all-in-one power unit, onto which guide grooves can be built, is available as a motorized conveyor pulley under the name VAN GORP from Van Gorp Corporation, Pella, Iowa.

The guide grooves are sized and configured in cooperation with selection of diameter of cable 29 to be used between the car and the winding unit, whereby the grooves receive and wind up the cable in a helical pattern as the car is lifted, and dispense the cable as the winding unit unwinds the cable thereby to lower the car. The internal drive unit thus drives rotation of the outer housing. The car is lowered by turning the winding unit so as to unwind cable from the outer surface of the outer housing. The car is raised by turning the winding unit so as to wind up the cable on the outer housing. A conventional brake 48 is preferably included as part of the lift apparatus.

So long as the range of the path of travel of the car is limited to no more than 50 feet, conventional cables can be used to support the car, and to lift and lower the car in the configuration shown, and the length of cables required to be received and stored on the winding unit is sufficiently small to be received and stored on the above noted all-in-one unit 27. In addition, so long as the load capacity of the car is limited to residential loads of up to e.g. residential code limits, the cables can be of sufficiently small diameter as to be readily received and stored on the outer housing of a reasonably-sized power unit 27.

The location of the lift apparatus is critical to achieving the combined objectives of the invention, of (i) convenience of use of the car, (ii) economics of use of premium value floor space in the building, and (iii) simplicity and economy of installation. Accordingly, the lift apparatus must be positioned so that the car can travel to the highest of the floors being serviced by the elevator without the lift apparatus interfering with movement of the car. In addition, the elevator lift apparatus, and any other drive and control utilities, are positioned away from the premium space on the main floor of the building, and are preferably located at or adjacent the top of the highest floor being serviced in the building. As used herein, the top of a floor is represented by the ceiling of the habitable space represented by the floor.

By positioning the lift apparatus such that the lift apparatus is above the top of the elevator when the elevator is at the upper limit of the range of movement of the elevator, the cables can extend directly up from the car to the winding unit, in a straight-line direction, without passing over any sheave or other turning device. Thus, by positioning the lift apparatus in a preferred position, one avoids use of any turning devices. Avoidance of use of turning devices eliminates the cost of acquisition of such turning devices, as well as the cost and time involved in installation and maintenance of such turning devices. Further, one avoids the cost of the additional lengths of cable which necessarily attend use of such turning devices.

Thus, a number of economies attend placement of the lift apparatus as conceived in this invention. The lift apparatus, including motor and winding unit, are preferably contained in a single housing as best illustrated in FIGS. 1 and 2 wherein the drive motor (not shown in FIGS. 10 and 2) is disposed inwardly of outer housing 36. In less preferred embodiments, drive motor 23 is a separate and distinct unit connected to outer housing 36 by a drive mechanism such as a drive shaft 42. Where the separate drive unit and winding unit are employed, drive shaft 42 is preferably short such that the drive unit and winding unit are in close proximity to each other, e.g. separated by no more than about 12 inches, preferably no more than about 3 inches. Such separate and distinct drive unit and winding unit can be independently mounted to the guide rail structure, or can be mounted to a common mounting platform as at mounting bracket 55, which platform or bracket is mounted to the guide rail structure.

Whatever the separation, if any, between the drive unit and the winding unit, the winding unit must be properly positioned to receive cable as the car is lifted, and to dispense cable as the car is lowered, without excessive use of turning devices to guide the cable along the path traversed by the cable between the winding unit and the car.

As a general statement, cable 29 extends, as elongate connection apparatus, between lift apparatus 22 and car 16, for lifting and lowering the car. A specific feature of the invention is that the lift apparatus, especially winding structure such as outer housing 36 on the lift apparatus, is positioned on guide rail structure 14, with respect to the path of travel of the car, such that the cable extends, from the car, upwardly to the winding structure, without substantial change of direction of extension of the cable between the car and the winding structure.

Guide rail structure 14 can be any guide rail structure known for use in the elevator art, and those skilled in the art can readily specify suitable such guide rail structure and materials. Thus, size and shape of the respective guide rails can be any size and shape conventionally compatible with residential elevator use, and can comprise any material which is compatible with residential elevator use. Preferred, and typical material for guide rails 14 is steel.

Guide rail structure 14 can employ a pair of guide rails as illustrated in the drawings. As alternative, guide rail structure 14 can be a single rail (not shown), or can be more than 2 rails, for example 3 guide rails (not shown) In any event, the purpose of the rail is to fulfill the conventional support role of acting as a mounting interface between the building and the car. Any mounting interface which is effective to support the car from the building is acceptable for guide rail structure 14.

Where multiple guide rails are used, the guide rails are preferably assembled to each other at a manufacturing location. For example, the guide rails are laid out parallel to each other and are bolted to each other using a plurality of connecting brackets 15 spaced along the lengths of the rails.

In some preferred embodiments, lift apparatus 22 is mounted to guide rail structure 14 using e.g. the specially designed and configured lift apparatus mounting bracket 55. In such instance, the lift apparatus mounting bracket is mounted to the guide rail structure at the manufacturing plant such that the precision alignment available in manufacturing operations can be used to align mounting holes in the lift apparatus bracket to suitably positioned holes in the guide rail structure, and to align mounting holes in the lift apparatus to mounting holes in the lift apparatus bracket. Cooperating mounting holes in the lift apparatus and the lift apparatus mounting bracket receive mounting bolts, and mount the lift apparatus to lift apparatus mounting bracket 55, and thus to the guide rail structure, all with a degree of alignment precision available at a manufacturing plant. The lift apparatus bracket and/or the lift apparatus can, in the alternative, be e.g. welded to the guide rail structure or can be otherwise mounted to the guide rail structure.

In some embodiments, an upper one of the guide rail brackets can be used both to secure the guide rails to each other and to mount the lift apparatus to the guide rail structure, thereby obviating the need for the lift apparatus mounting bracket and correspondingly providing economy of use of materials.

By mounting the lift apparatus directly to the guide rail structure, and by fabricating interfacing such mounting structure in the manufacturing environment, increased precision of alignment can be achieved. In addition, on-site elevator installation time is decreased as no mounting location need be located and prepared, or built, for the lift apparatus at the installation site. In addition, since the exact location of the lift apparatus is consistent from installation to installation, the precise length of lift cables needed can be determined at the time of manufacture of the elevator, whereby lift cables can be shipped from the factory with the elevator, thereby taking advantage of any volume buying capability of the manufacturer, while providing consistency of cable specification on each such residential elevator.

Car 16 can be any conventionally known car or combination of car plus car frame. Accordingly, the car can be made of a wide variety of materials which are known to be suitable for construction of elevator cars. There can be mentioned, for example, wood, steel, glass, plastics, and various other materials. Where a frame is used, the material selected for use as the frame must be suitably strong to properly support the car in routine use. Where no frame is used, the materials and structure which comprise the car must be suitably strong as to be supported directly from guide rail structure 14 in routine use of the elevator.

The typical car 16 has a top wall shown at 18, a front wall 56, opposing left and right side walls 58 and a back wall 59. Front wall 56 in the illustrated embodiments comprises a door 60 for entrance into, and exit from, the inner space inside car 16.

Since simplicity and simplification are objectives of the invention, elevators of the invention desirably avoid use of complex apparatus. Thus, where possible, the path traversed by the cable between the elevator and the lift apparatus is devoid of sheaves or any other direction changing device.

Similarly, only in rare instances will counterbalances be used. In general residential elevators of the invention are devoid of any counterbalance effective to provide greater than about 20 percent of the lift force required to lift the car when the car is loaded to capacity.

A residential elevator of the invention can be installed as follows. The guide rail structure is mounted to the building in the typical upright, preferably vertical, orientation. The car is mounted to the guide rail structure such that the car has a range of upward and downward movement on the guide rails along a path of travel between the upper limit and the lower limit. The upper limit is that elevation to which the car must travel to service the highest floor being serviced by the elevator. The lower limit is that elevation to which the car must travel to service the lowest floor being serviced by the elevator. Cable or other elongate connection apparatus is connected between the car, and the winding unit at the lift apparatus.

In use, the elevator car is lifted and lowered along the guide rail structure by lifting apparatus 27, such that the car traverses along the path of travel between the upper limit and the lower limit, including to any intervening floors or other stops along the path of travel of the car. The cable is wound onto, or unwound from, the winding unit as needed, and extends between the car and the winding unit, preferably without substantial change of direction of extension of the cable between the car and the winding unit. Preferably the cable extends directly in a straight-line path between the car and the winding unit, with no change of direction, no passing over any sheave or any other direction-changing device.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. A residential elevator mounted in a building, said elevator comprising:
(a) guide rail structure mounted to the building in an upright orientation;
(b) a car mounted to said guide rail structure, said car having a top, and a range of upward and downward movement on said guide rail structure along a path of travel between an upper limit and a lower limit;
(c) lift apparatus operable for lifting and lowering said car, said lift apparatus being mounted to said guide rail structure at a location above a height of the top of said car when said car is at the upper limit of movement; and
(d) elongate connection apparatus connecting said lift apparatus to said car, for lifting said car and lowering said car.

2. A residential elevator as in claim 2 wherein said guide rail structure comprises a plurality of rails, suitable for mounting to the building in an upright orientation.

3. A residential elevator as in claim 1, said lift apparatus comprising an outer housing, and an internal drive unit disposed inwardly of said outer housing, said internal drive unit driving rotation of said outer housing, said elongate connection apparatus being connected to said outer housing and being wound onto, and unwound from, an outer surface of said outer housing as said car travels upwardly and downwardly along the path of travel.

4. A residential elevator as in claim 3, the outer surface of said outer housing comprising guide grooves extending about a circumference of the outer surface, the guide grooves being sized and configured to receive said elongate connection apparatus and to guide helical winding of said elongate connection apparatus on said lift apparatus.

5. A residential elevator as in claim 4 wherein said elongate connection apparatus comprises cable.

6. A residential elevator as in claim 1, said lift apparatus comprising an internal drive unit, a brake, and an outer housing having an outer surface configured to receive said elongate connection apparatus as said car is lifted, and to wind said elongate connection apparatus on an outer surface of said outer housing in a helical pattern.

7. A residential elevator as in claim 1, said lift apparatus comprising a drive unit containing a drive mechanism, and a winding unit comprising an outer housing comprising said winding structure, said winding structure being configured to receive and wind said elongate connection apparatus, said lift apparatus further comprising drive apparatus connecting a drive output of said drive mechanism to a winding input of said winding unit.

8. A residential elevator as in claim 7, said drive unit and said winding unit comprising separate and distinct structures, independently mounted to said guide rail structure.

9. A residential elevator as in claim 1, said elevator being devoid of any counterbalance effective to provide greater than 20 percent of a lift force required to lift said car when said car is loaded to capacity.

10. A residential elevator as in claim 1, said elongate connection apparatus traversing a lift path between said car and said lift apparatus, the lift path being devoid of intervening sheaves between said car and said lift apparatus.

11. A residential elevator as in claim 1, said elongate connection apparatus extending, from said car, upwardly to said winding structure along a straight-line connection path.

12. A residential elevator mounted in a building, said residential elevator being limited to movement along a path of travel no more than 50 feet long, said residential elevator comprising:
(a) guide rail structure mounted to the building in an upright orientation and extending generally along the 50 foot path of travel;
(b) a car mounted to said guide rail structure, said car having a top, and a range of upward and downward movement on said guide rail structure along the path of travel between an upper limit and a lower limit thereby to service the no more than 50 feet of travel;
(c) lift apparatus operable for lifting and lowering said car, said lift apparatus comprising an outer housing, and an internal drive unit disposed inwardly of said outer housing, said internal drive unit driving rotation of said outer housing, said lift apparatus being mounted to said guide rail structure at a location such that said outer housing is above a height of the top of said car when said car is at the upper limit of movement; and
(d) elongate connection apparatus connecting said lift apparatus to said car, for lifting said car and lowering said car.

13. A residential elevator as in claim 12, the outer surface of said outer housing comprising guide grooves extending about a circumference of the outer surface, the guide grooves being arranged in a helical pattern, and being sized and configured to receive said elongate connection apparatus and to guide helical winding of said elongate connection apparatus on the outer surface of said outer housing.

14. A residential elevator as in claim 13 wherein said elongate connection apparatus comprises cable.

15. A residential elevator as in claim 12, said elevator being devoid of any counterbalance effective to provide greater than 20 percent of a lift force required to lift said car when said car is loaded to capacity.

16. A residential elevator as in claim 12, said elongate connection apparatus traversing a lift path between said car and said lift apparatus, the lift path being devoid of intervening sheaves between said car and said lift apparatus.

17. A residential elevator as in claim 12, said elongate connection apparatus extending, from said car, upwardly to said winding structure along a straight-line connection path.

18. A method of installing an elevator in a building, the method comprising:
(a) mounting guide rail structure to the building in an upright orientation;
(b) mounting a car to the guide rail structure, the car having a top, and a range of upward and downward movement on the guide rail structure along a path of travel between an upper limit and a lower limit;
(c) mounting lift apparatus, operable for lifting and lowering the car, to the guide rail structure at a location such that the lift apparatus is above a height of the top of the car when the car is at the upper limit of movement; and
(d) mounting elongate connection apparatus to the lift apparatus and to the car and thus connecting the lift apparatus to the car, for lifting the car and lowering the car

19. A method as in claim 18, including installing a plurality of rails as the guide rail structure.

20. A method as in claim 18, including selecting, as the lift apparatus, a lift apparatus comprising an outer housing, and internal drive structure disposed inwardly of the outer housing, the outer housing being configured to receive the elongate connection apparatus as the car is lifted, and to wind the elongate connection apparatus on an outer surface of the outer housing.

21. A method as in claim 18 wherein the lift apparatus comprises a drive unit contained in a first housing and a winding unit comprising the winding structure contained in a second housing, the method comprising mounting the winding unit in a location such that the winding structure is positioned with respect to the path of travel of the car such that the elongate connection apparatus extends from the car, upwardly to the winding structure without substantial change of direction of extension of the elongate connection apparatus between the car and the winding structure.

22. A method as in claim 18, including using the lift apparatus to provide at least 80 percent of a force, measured at the car, and required to lift the car when the car is loaded to capacity.

23. A method as in claim 18I, including traversing the elongate connection apparatus along a lift path between the car and the lift apparatus without passing the elongate connection apparatus over any sheaves.

24. A method of using an elevator, comprising:
(a) traversing an elevator car along an upstanding guide rail structure attached to a building, such that the elevator car traverses the guide rail structure along a path of travel between an upper limit and a lower limit; and
(b) winding elongate connection apparatus on a winding unit which is mounted to the guide rail structure, at a height which, at the upper limit of travel of the car, is above a top of the car.

25. A method as in claim 24 wherein the elongate connection apparatus extends upwardly, from the car, to the winding unit without substantial change of direction of extension of the elongate connection apparatus between the car and the winding unit.

26. A method as in claim 24 wherein the elongate connection apparatus comprises cable, and wherein an outer surface of the winding unit is configured with circumferentially-extending helical grooves, and wherein the winding of the cable results in deployment of the cable in the grooves.

27. A method as in claim 24, including traversing the elongate connection apparatus along a lift path between the car and the lift apparatus, without passing the elongate connection apparatus over any sheaves.
